(19) United States
(12) Patent Application Publication
(10) Pub. No.: US 2009/0222749 A1
(43) Pub. Date: Sep. 3, 2009

(54) APPARATUS AND METHOD FOR AUTOMATED CREATION AND UPDATE OF A WEB SERVICE APPLICATION

(75) Inventors: Dan Cristian MARINESCU, Versailles (FR); Laurent Joel Gabriel PONTIER, Bailly (FR)

Correspondence Address: SAP Global IP c/o Cooley Godward Kronish LLP;William S. Galliani, 777 6th Street NW, Suite 1100, Washington, DC, 20001, US

(73) Assignee: BUSINESS OBJECTS, S.A., Levallois-Perret (FR)

(21) Appl. No.: 12/040,789

(22) Filed: Feb. 29, 2008

(51) Int. Cl. G06F 3/048

(52) U.S. Cl. 715/764

(57) ABSTRACT

A computer readable storage medium includes executable instructions to compare a definition of a web service used by an application to a current definition of the web service, where the definition of the web service includes a description of a plurality of data parameters, and where the application includes a graphical user interface including at least one part that displays a data object representing an input to or an output from the web service. The computer readable storage medium further includes executable instructions to create a first updated application based on the application and the current definition of the web service, including executable instructions to modify the at least one part of the graphical user interface to correspond to the current web service definition.

### FIELD OF THE INVENTION

The present invention relates generally to the design and creation of a software application. More particularly, this invention relates to the automated creation and update of a web service application.

### BACKGROUND OF THE INVENTION

Business Intelligence (BI) generally refers to software tools used to improve business enterprise decision-making. These tools are commonly applied to financial, human resource, marketing, sales, service provider, customer, and supplier analyses. More specifically, these tools can include reporting and analysis tools for presenting information, content delivery infrastructure systems for delivering and managing reports and analytics, and data warehousing systems for cleansing and consolidating information from disparate sources. BI tools may work with data management systems, such as relational databases or On Line Analytic Processing (OLAP) systems used to collect, store, and manage raw data.

BI tools that can be adapted to and elaborated on to meet a user's specific needs can facilitate user productivity by, for example, accepting desired inputs, producing desired outputs, and presenting inputs, outputs, and other related data in a desired form. A dynamic web service application including a graphical user interface (GUI) may be designed to accept input data for, and display output from, one or more web services that may change periodically. When a web service definition changes, human intervention is typically needed to modify the application to correspond to the latest web service definition. It may not be an efficient use of time for a software designer to repeatedly make minor changes to the application resulting from small changes to a web service definition, such as selecting different GUI display components to display web service outputs that have changed from a first to a second data type.

In view of the foregoing problem, it would be desirable to provide improved techniques for automating the creation and update of a web service application.

### SUMMARY OF THE INVENTION

This invention includes a computer readable storage medium with executable instructions to compare a definition of a web service used by an application to a current definition of the web service where the definition of the web service includes a description of a plurality of data parameters, and where the application includes a graphical user interface including at least one part that displays a data object representing an input to or an output from the web service. The computer readable storage medium further includes executable instructions to create a first updated application based on the application and the current definition of the web service, including executable instructions to modify the at least one part of the graphical user interface to correspond to the current web service definition.

In another embodiment, the invention includes a system. The system includes a client containing an application including a definition of a web service and a graphical user interface including at least one part that displays a data object representing an input to or an output from the web service, where the definition of the web service includes a description of a plurality of data objects. The system further includes a server that compares the definition of the web service to a current definition of the web service contained on the server, and that creates a first updated application based on the application and the current definition of the web service, including modifying the at least one part of the graphical user interface to correspond to the current web service definition.

### BRIEF DESCRIPTION OF THE DRAWINGS

For a better understanding of the nature and objects of the invention, reference should be made to the following detailed description taken in conjunction with the accompanying drawings, in which:

FIG. 1 illustrates a system for enabling the automated creation and update of a web service application, in accordance with one embodiment of the present invention;

FIG. 2 illustrates operations associated with the automated update and subsequent use of a web service application, in accordance with one embodiment of the present invention;

FIG. 3 illustrates operations associated with the automated creation of a web service application, in accordance with one embodiment of the present invention;

FIG. 4 illustrates an example of a graphical user interface for creating a web service query, in accordance with one embodiment of the present invention;

FIG. 5 illustrates an example of a graphical user interface for creating and editing an input graphical user interface, in accordance with one embodiment of the present invention;

FIG. 6 illustrates an example of a graphical user interface for creating and editing an output graphical user interface, in accordance with one embodiment of the present invention;

FIG. 7 illustrates an example of a graphical user interface for providing a workflow description, in accordance with one embodiment of the present invention;

FIG. 8 illustrates an example of a graphical user interface for designing and updating an input/output graphical user interface, in accordance with one embodiment of the present invention; and

FIG. 9 illustrates an example of an input/output graphical user interface corresponding to the graphical user interface of FIG. 8.

### DETAILED DESCRIPTION OF THE INVENTION

The invention is operative with a data source. A data source is an information resource. Data sources include sources of data that enable data storage and retrieval. Data sources may include databases, such as, relational, transactional, hierarchical, multidimensional (e.g., OLAP), object oriented databases, and the like. Further data sources may include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC) and the like. Data sources may also include a data source where the data is not stored like data streams, broadcast data, and the like.

The invention is also operative with Web Services. Web Services (WS) are a class of protocols for inter-system communication. WS are for distributed computing and network communication and provide a common object model, make information about the data available to other systems, and add metadata to the data requested. On top of this basic communication framework other services can be added. One kind of WS includes an eXtensible Markup Language (XML) base that facilitates interoperability among systems. A Web Service has an interface that is specified in a format such as the Web Service Description Language (WSDL). A WS can use SOAP (also known as Simple Object Access Protocol) as the foundation layer providing the basic communication framework. SOAP is a protocol for exchanging XML messages over a computer network. Other systems interact with the web service in a manner prescribed by the interface of the WS.

This invention is also operative with a semantic abstraction or universe. Semantic abstraction or universe is the term for a semantic layer that describes an underlying base data source. A semantic abstraction can be a level of abstraction based on a relational, OLAP, or other data source or a combination of more than one existing semantic layers. A universe is a specific form of semantic abstraction where the semantic abstraction includes data model objects that describe the underlying data source and define dimensions, attributes and measures that can be applied to the underlying data source and data foundation metadata that describes a connection to, structure for, and aspects of the underlying data source. A data model object is an object defined within a semantic domain that represents a dimension of the underlying data source, represents relationships between dimension members and attributes, or provides calculations from, based on or designed to be applied to an underlying data source. Typically, in a universe a data model object is assigned a common business term such that the user does not need to understand the specific logic of the underlying data source but can work with familiar terminology when constructing queries or otherwise accessing the data. Examples of common business terms include: customer, employee, product line, revenue, profit, attrition, fiscal year, quarter, and the like.

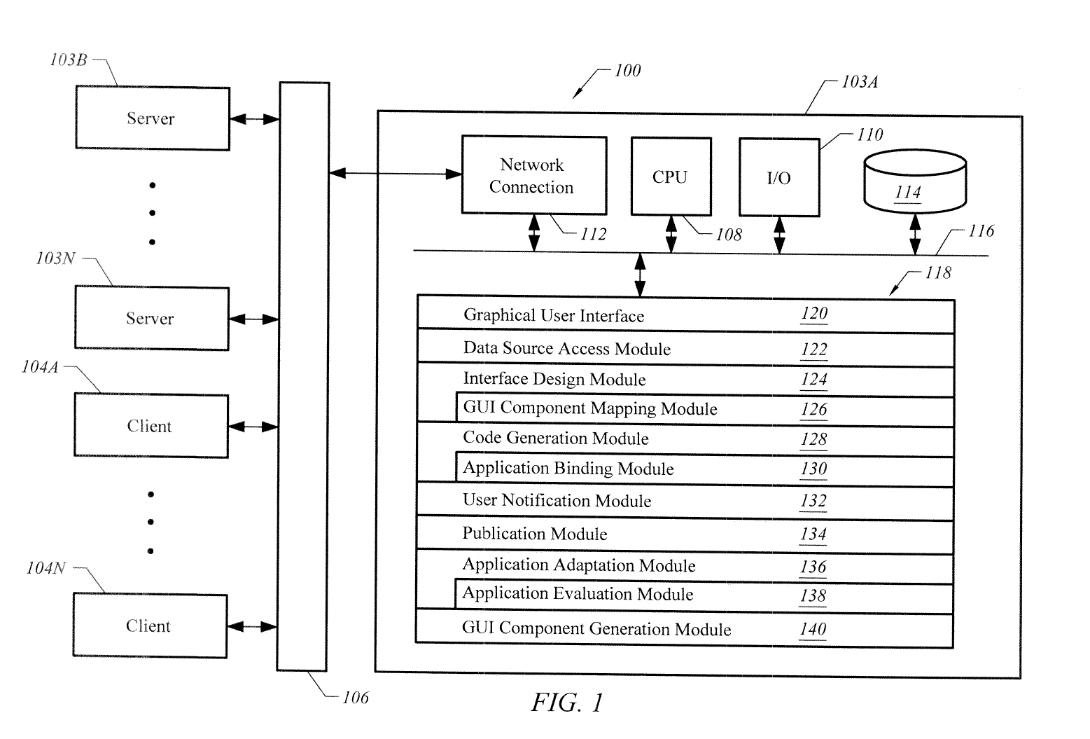

FIG. 1 illustrates a system 100 for enabling the automated creation and update of a web service application, in accordance with one embodiment of the present invention. One goal of the system 100 is to automate the creation and update of individual parts of a GUI of the web service application, where the graphical user interface displays at least one data object representing an input to or an output from one or more web services. In a first embodiment, the GUI includes one or more pages that display inputs to and outputs from a particular web service. The system 100 can automatically design these pages of the GUI to correspond to the definition of this web service, and create an application corresponding to this web service definition. If the definition of this web service changes to a new definition, then the system 100 can automatically update the pages of the GUI to correspond to the new definition of this web service. The system 100 may then create an updated application corresponding to the new definition of this web service. This automatic update helps to minimize the time that a designer spends maintaining an application that is serving clients as the web service definition changes.

In a second embodiment, the GUI may include multiple parts, where each part interfaces with a different web service, and each part includes one or more pages that display inputs to and outputs from an individual web service. The system 100 again can automatically design and/or update the pages of the GUI to correspond to the current definition of each web service. In this embodiment, there is a workflow description that links the multiple parts of the GUI. The workflow description may need to be modified upon a change in a web service definition, and this modification may require user intervention. The system 100 may determine, prior to compilation, that the workflow description needs modification. The system 100 may then request that a designer modify the workflow description. The system 100 may attempt to build an application based on the workflow description and corresponding to the current definition of each web service. If the build succeeds, the application is executable by a user. If the build fails, a designer can determine whether the failure is due to an inconsistency in the workflow description caused by a change in a web service definition. If there is an inconsistency, the designer can modify the workflow description to correspond to the current web service definition. The designer can save redesign time by using the automatic modifications that the system 100 has already made to the individual parts of the GUI. Alternatively, the designer can redesign one or more individual parts of the GUI to, for example, use particular GUI components desired by the designer rather than GUI components automatically selected by the system 100.

The system 100 includes a transmission channel 106 connecting a computer 103A with servers 103B-103N and clients 104A-104N. The computer 103A includes standard components, such as a network connection 112, a CPU 108, input/output devices 110, and a data source 114, which communicate over a bus 1116. The memory 118 stores a set of executable programs that are used to implement functions of the invention. The servers 103 and clients 104 typically include the same standard components. The data source 114 may be internal and/or external to the computer 103A.

In an embodiment of the invention, the memory 118 includes executable instructions establishing the various modules shown in FIG. 1. The graphical user interface module 120 allows the user to interact with the other modules contained in memory 118. The data source access module 122 is used to access one or more data sources. The data sources may be internal to the computer 102, such as data store 114, or external data sources accessible via the transmission channel 106. The data sources may store one or more of data that may be transmitted over web services, web service definitions, and web service application source code.

The interface design module 124 determines what GUI components correspond to data objects representing an input to or an output from a web service. The GUI component mapping module 126 maps each data object to a GUI component. As part of the mapping, the GUI component mapping module 126 may take into account the type of deployment platform. The interface design module 124 also arranges the GUI components that map to data objects into a default GUI layout, allows the user to link parts of the GUI using a workflow description, and allows the user to edit the default GUI. The GUI component generation module 140 may rely upon standard techniques to produce GUI components for use by the interface design module 124 and the GUI component mapping module 126.

The code generation module 128 generates source code for an application so that the application is executable on a deployment platform. The source code mainly includes the instantiation of the user interface needed for the user to interact with the application and the calls to backend components. If a workflow description links parts of the GUI, the application binding module 130 binds the parts of the GUI into a combination of parts. The code generation module 128 can then generate source code for an application from the combination of parts.

The notification module 132 provides a notification of the creation of a web service application to a user. The notification module 132 also processes a confirmation received from a user accepting the web service application. The publication module 134 publishes the web service application to a repository.

The application adaptation module 136 builds the application and updates it based on a current web service definition without any user intervention. The application evaluation module 138 compares the web service definition used by an application to the current web service definition.

The modules in memory 118 are exemplary. The function of individual modules may be combined. In addition, the modules may reside on a single computer 102, or may be distributed across a network. For example, an application adaptation module 136 may reside on any server 103, and may evaluate and update applications executing on one or more of clients 104 and/or servers 103. The applications may also have been designed and generated by interface design module 124 and code generation module 128 on any server 103. It is the processing associated with the invention that is significant, not where or how the processing is implemented.

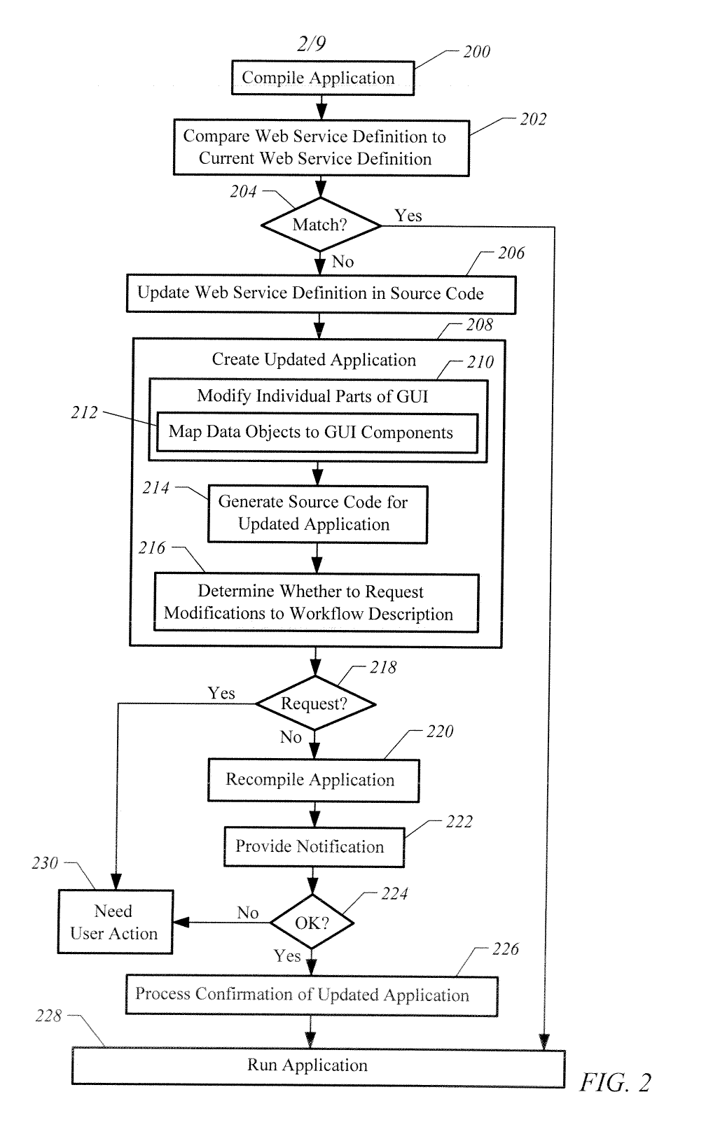

FIG. 2 illustrates operations associated with the automated update and subsequent use of a web service application, in accordance with one embodiment of the present invention. The application adaptation module 136 compiles the source code for the application (block 200). In one embodiment, the source code of the application is stored on the client 104 prior to compilation. The client 104 may be a rich client, also known as a thick client, a fat client, or a heavy client. A rich client is a client that performs the bulk of any data processing operations itself, and does not necessarily rely on a server. The fat client is most commonly a personal computer. Programming environments for rich clients include Curl, Delphi, Droplets, Java, Win32, and X11. The web service application may be a Rich Internet Application (RIA), which is a web application that has the features and functionality of a traditional desktop application. RIAs typically transfer the processing necessary for the user interface to the web client but keep the bulk of the data (i.e., data maintaining the state of the program, data used during processing, etc.) back on an application server, which is represented by the application adaptation module 136. The client of a RIA is typically a rich client.

In another embodiment, the source code of the application is stored on a server 103 during compilation by the application adaptation module 136. The web service application may be exposed as a web application that is called from a remote client 104. The client 104 may be a thin client. A thin client, in contrast to a rich client, depends primarily on the server 103 to perform the bulk of data processing activities.

The application evaluation module 138 then compares the web service definition used by the application to a current web service definition (block 202). A web service definition may include a description of a plurality of data parameters and operations. In one embodiment, the web service definition used by the application is stored locally with the application. The current web service definition may be contained in a master version of the application source code stored on a server 103. Through the comparison, the application evaluation module 138 can detect changes in the web service definition. These changes may include at least one of parameter modifications, addition of new parameters or operations, removal of parameters or operations, and changes in parameter type. The comparison may occur after each download of the application to a client 104. For example, if application source code is downloaded to the client 104, then the comparison may occur after compilation of the application source code on the client 104. Alternatively, the comparison may occur for each call of the GUI of the application, where the application is exposed as a web application by a server 103.

If the comparison (block 202) indicates a match of the locally stored web service definition and the current web service definition (block 204), then the application stored on the client 104, or the call to the application from a remote client 104, is ready to be executed (block 228). Otherwise the application adaptation module 136 may update the web service definition in the application source code (block 206).

The updated application is then created based on the application and the current definition of the web service (block 208). Each part of the GUI of the application is modified to correspond to the current web service definition by the interface design module 124 (block 210). In one embodiment, the GUI contains a single application part that interfaces with a single web service. A part may include one or more pages or forms containing typical graphical elements, such as buttons, text boxes, checkboxes, combo boxes, lists, radio buttons, menus, tables, charts, and links. In another embodiment, the GUI may include multiple parts, where each part interfaces with a different web service, and each part includes one or more pages that display inputs to and outputs from an individual web service. The multiple parts may be linked to each other using a predefined workflow description. For example, the workflow description may include at least one mapping of an output of a first application part to one or more inputs of other application parts, and may define the sequence of application parts.

The modification (block 210) may include the automatic mapping of a data object to a GUI component by the GUI component mapping module 126 (block 212). This mapping may be based on a GUI layout template selected by a user. The GUI uses the GUI component to display the data object, where the data object represents an input to or an output from a web service. There are typically multiple GUI components to which a data object may be mapped for both GUI input and GUI output. For both GUI input and GUI output, one of these GUI components may be predefined or user selected as a default for each type of data object. In one embodiment, a free form, or freely definable, numeric data object or string data object may be mapped to a GUI component such as a writable text box for a GUI input, or a read-only text box for a GUI output. A free form numeric data object may alternatively be mapped to a GUI slider for a GUI input. A data object representing an enumerated list may be mapped, for a GUI input, to GUI components such as a dropdown list (or combo box) or a radio button group. A data object representing a date may be mapped, for a GUI input, to a date-specific GUI component such as a dropdown list (or combo box) or a radio button group with available values restricted to dates. A Boolean data object may be mapped, for a GUI input, to GUI components including a writable checkbox or a two-item radio button group. For a GUI output, a Boolean data object may be mapped to GUI components including a read-only text box or a read-only checkbox. A dataset containing more than one element in each of one or more dimensions may be mapped, for a GUI input, to GUI components including a writable table with one table element per element of the dataset. For a GUI output, a dataset containing more than one element in one dimension may be mapped to a read-only table with one table element per element of the dataset, a bar chart, a pie chart, or any other type of chart commonly used to display a one-dimensional data set. A dataset containing more than one element in two or more dimensions may be mapped to a read-only table with one table element per element of the dataset, a bar chart, or any other type of chart commonly used to display a multi-dimensional data set. A database query result, such as the result of a Structured Query Language (SQL) SELECT query, is often in the form of a dataset containing more than one element in each of one or more dimensions, and thus may be mapped to a chart as described above.

In one embodiment, a data object representing a new web service parameter is mapped to a default GUI component by the GUI component mapping module 126. A data object representing a web service parameter with a changed type is mapped to a default GUI component that replaces the GUI component previously displaying the data object. For example, if a web service output has changed from an integer to a Boolean data type, the system 100 can automatically change the GUI component used to display this web service output from a text box to a checkbox.

The code generation module 128 then generates source code for an updated application that corresponds to the current web service definition (block 214). The generated source code includes the default GUI components that map to the data objects displayed in the GUI of each part of the updated application. The GUI components may be generated by the GUI component generation module 140. The generated source code may be customized so that the updated application is executable on a predefined or user selected deployment platform, such as a rich client 104 or a server 103 with a particular programming environment. The generated source code may also be in a predefined or user selected application format. For example, different builders can be added as plug-in modules to the code generation module 128, allowing creation of the existing applications in new formats.

The application evaluation module 138 may then determine whether to request modifications in the workflow description (block 216). This determination may be done prior to compilation. In one embodiment, the application evaluation module 138 requests modifications to the workflow description (block 218) if a changed parameter in a web service definition is included in the at least one mapping of an output of a first application part to one or more inputs of other application parts, or if the changed parameter affects the sequencing of application parts in the workflow description. If this request is made, then user action may be needed to modify the workflow description (block 230). Otherwise, the application adaptation module 136 recompiles the source code for the updated application (block 220).

After recompilation (block 220), the notification module 132 may provide a notification to the application designer or others responsible for maintaining the application (block 222). If the recompilation fails (block 224), this notification may provide information describing the error, and user action may be needed to fix the error (block 230). If recompilation is successful (block 224), this notification may indicate the creation of the updated application, and may include a description of all of the changes made to the updated application by the system 100. If the changes are acceptable, the application designer may accept the updated application. The notification module may process this confirmation accepting the updated application (block 226). The application stored on the client 104, or the call to the application from a remote client 104, is then ready to be executed (block 228).

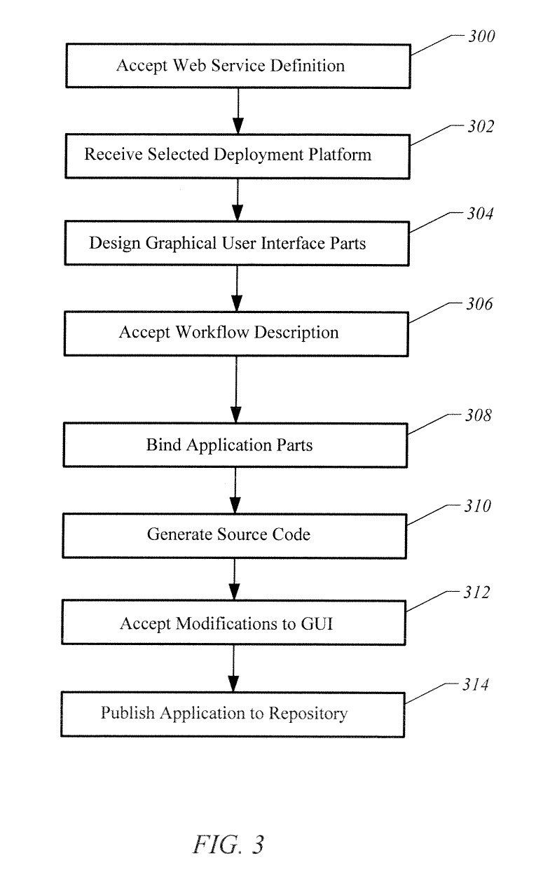

If the recompilation (block 224) fails, the application designer may review the reasons for the build failure. The failure may be due to an inconsistency in the workflow description caused by a change in a web service definition. The changes made to the updated application by the system 100 reported to the application designer (block 222) may also not be acceptable. In either case, the designer may use the automated application creation functionality of the system 100, as described in FIG. 3.

FIG. 3 illustrates operations associated with the automated creation of a web service application, in accordance with one embodiment of the present invention. The data source access module 122 accepts one or more web service definitions (block 300). The web service definitions may be stored in a data source. The web service definitions may be predefined, or may be modified or created by a user using the graphical user interface 120. The data source access module 122 also receives a selected deployment platform (block 302). The deployment platform may be predefined, or may be selected by a user using the graphical user interface 120. The web service definitions and the selected deployment platform information may be provided by the data source access module 122 to the interface design module 124.

The interface design module 124 then automatically designs the individual parts of the GUI of the web service application (block 304). Each part of the GUI of the application is designed to correspond to a web service definition by the interface design module 124, as described previously (see block 210). The design may include the automatic mapping of a data object to a GUI component by the GUI component mapping module 126, as described previously (see block 212).

The interface design module 124 then accepts designer input via the graphical user interface 120 defining a workflow description linking the individual parts of the GUI of the web service application (block 306). A previously existing workflow description linking parts of a GUI may be modified by a designer to fix an inconsistency in the workflow description caused by a change in a web service definition. In this embodiment, the modified workflow description corresponds to the current web service definition.

The application binding module 130 may then bind a plurality of parts of the GUI into a combination of parts based on the workflow description (block 308). The code generation module 128 then generates source code for the web service application (block 310), as described previously (see block 214). The interface design module 124 may then accept designer input via the graphical user interface 120 to modify the GUI (block 312). The source code of the application may then be published to a repository that may, for example, be accessible to clients 104 and/or servers 103 (block 314).

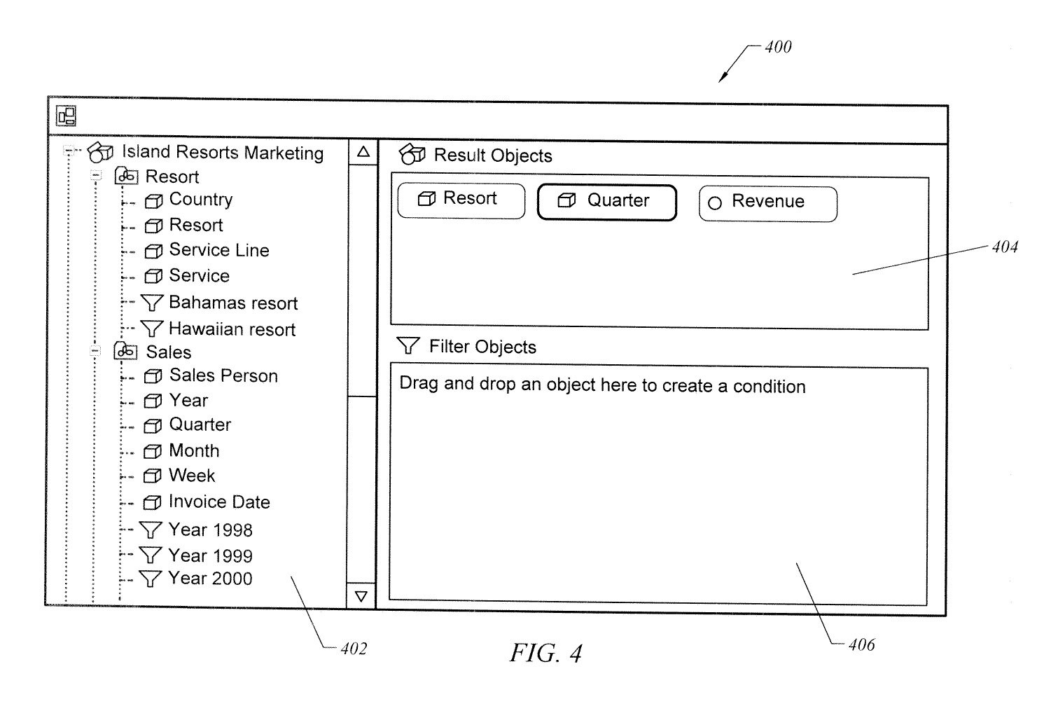

FIG. 4 illustrates an example of a graphical user interface for creating a web service query, in accordance with one embodiment of the present invention. A web service definition created or modified via query definition panel 400 may be provided as input to block 300 of FIG. 3. Panel 402 shows the available list of dimensions and measures in the selected universe. Panel 404 is a result object panel. This panel indicates the dimensions and measures that should be provided in the query result. Panel 406 is a filter object panel. This panel is where the user defines the filter parameters for the query.

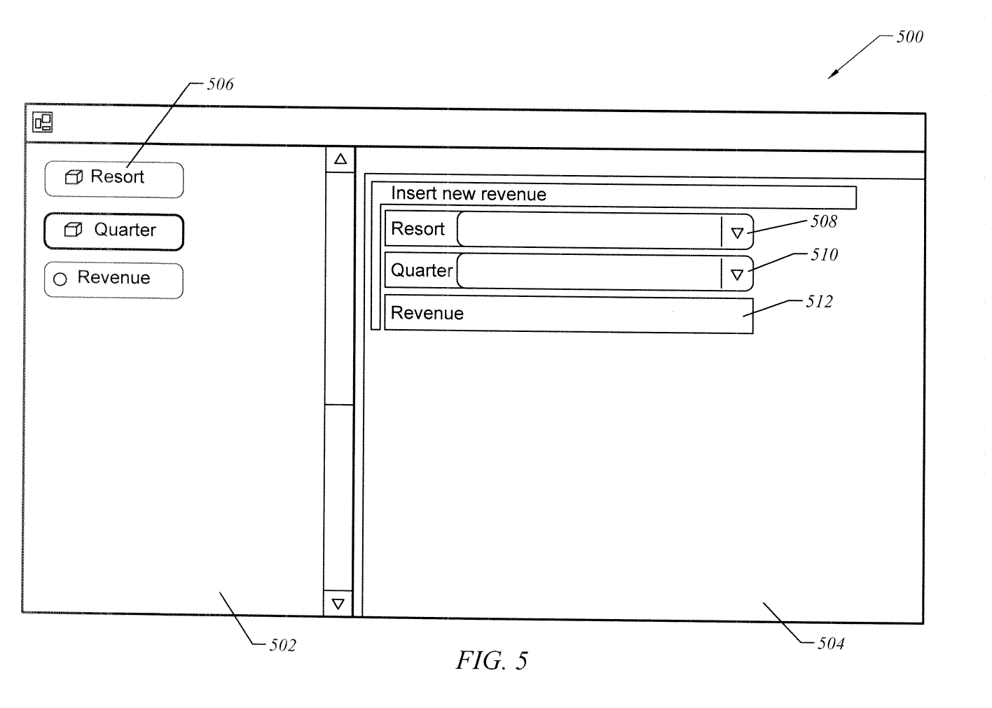

FIG. 5 illustrates an example of a graphical user interface for creating and editing an input graphical user interface, in accordance with one embodiment of the present invention. In one embodiment, the automatically generated GUI of FIG. 2 may be edited using the GUI designer panel 500. In another embodiment, the automatically generated GUI of block 310 of FIG. 3 may be edited using the GUI designer panel 500. Panel 502 shows the list of dimensions and measures (data objects) available for inclusion in the GUI. Panel 504 is the design view, which illustrates how the GUI page will look. Panel 506 displays the “Resort” data object. Panel 508 displays the “Resort” data object GUI component, which is a dropdown list. A dropdown list is automatically selected for this data object because this field must be populated from another table. Panel 510 displays the “Quarter” data object GUI component, which is a date-specific dropdown list. Panel 512 displays the “Revenue” data object GUI component, which is a writable text box enabling the input of free form numeric data.

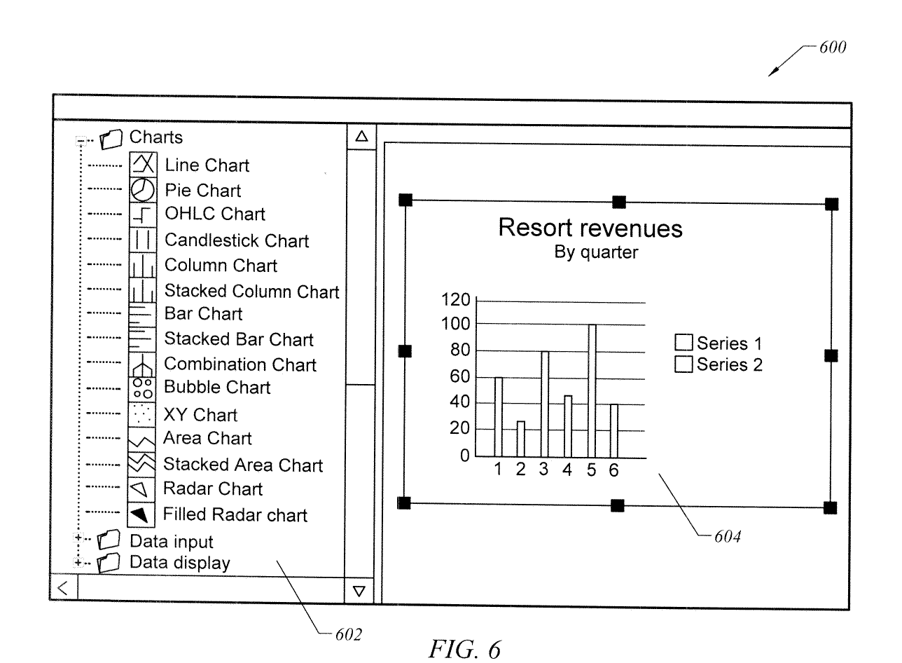

FIG. 6 illustrates an example of a graphical user interface for creating and editing an output graphical user interface, in accordance with one embodiment of the present invention. In one embodiment, the automatically generated GUI of FIG. 2 may be edited using the GUI designer panel 600. In another embodiment, the automatically generated GUI of block 310 of FIG. 3 may be edited using the GUI designer panel 600. Panel 602 shows the list of dimensions and measures (data objects) available for inclusion in the GUI. Panel 604 shows a line chart defined to illustrate resort revenue by quarter. The GUI component mapping module 126 can, for example, map a database query result to this chart type. The interface design module 114 can define the chart parameters based on the web service definition without user intervention.

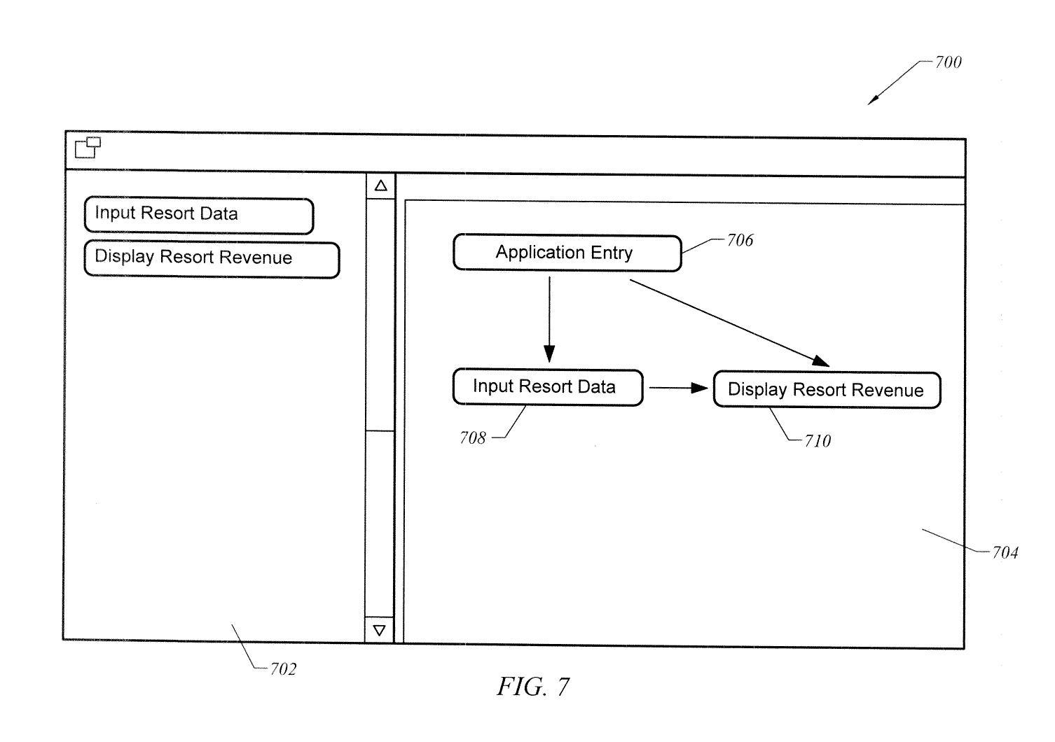

FIG. 7 illustrates an example of a graphical user interface for providing a workflow description, in accordance with one embodiment of the present invention. In one embodiment, the workflow description of block 306 of FIG. 3 may be provided by a designer using the GUI designer panel 700. Panel 702 shows a list of available parts for the GUI, where all the GUI components/pages associated with a single web service make up an application part. Panel 704 shows the workflow description for the application. Panel 706 shows the application entry step. This step is the required first step for every workflow description. The “next step” options from the application entry step (i.e., 708 and 710) indicate what options the user should have on first opening the application. Panel 708 shows the “Input Resort Data” application part. This application part allows the user to enter resort data using the GUI illustrated in FIG. 5. After inputting data, the user is directed to panel 710, showing the “Display Resort Revenue” application part, to view the effect of adding the new data. The “Display Resort Revenue” application part 710 allows the user to view resort revenue by quarter as illustrated in FIG. 6.

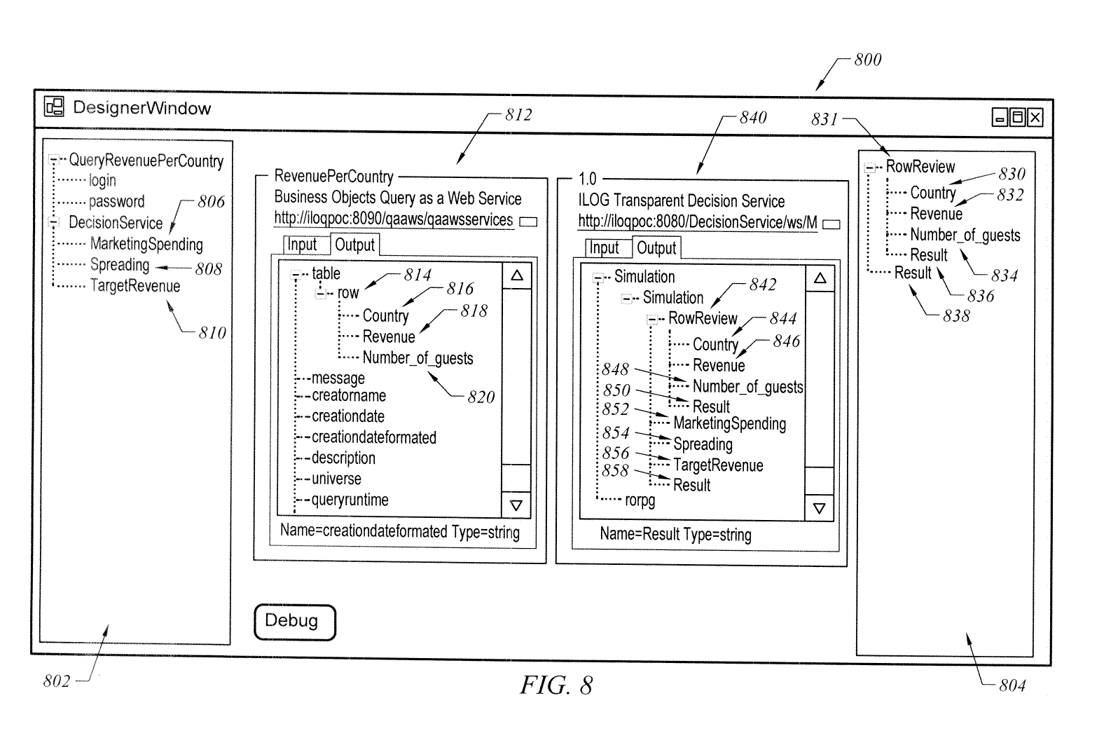

FIG. 8 illustrates an example of a graphical user interface for designing and updating an input/output graphical user interface, in accordance with one embodiment of the present invention. In one embodiment, the automatically generated GUI of FIG. 2 may be edited using the GUI designer panel 800. In another embodiment, the automatically generated GUI of block 310 of FIG. 3 may be edited using the GUI designer panel 800. Panel 802 shows externally visible inputs to the input/output GUI under design, such as “MarketingSpending” (panel 806), “Spreading” (panel 808), and “TargetRevenue” (panel 810). Panel 804 shows externally visible outputs of the input/output GUI under design, including row-based outputs “RowRevenue” (panel 831) and “Result” (panel 838). Each row of “RowRevenue” (panel 831) includes fields “Country” (panel 830), “Revenue” (panel 832), “Number_of_guests” (panel 834) and “Result” (panel 836).

Panel 812 shows a web service providing data to be displayed by and/or provided to the input/output GUI under design. Data to be displayed includes row-based parameters (panel 814), where each row includes parameters “Country” (panel 816), “Revenue” (panel 818), and “Number_of_guests” (panel 820). Panel 840 shows a web service receiving data from the input/output GUI under design. Data provided includes row-based parameters in “RowRevenue” (panel 842), where each row includes parameters “Country” (panel 844), “Revenue” (panel 846), “Number_of_guests” (panel 848), and “Result” (panel 850). Data provided also includes parameters “MarketingSpending” (panel 852), “Spreading” (panel 854), “TargetRevenue” (panel 856), and “Result” (panel 858).

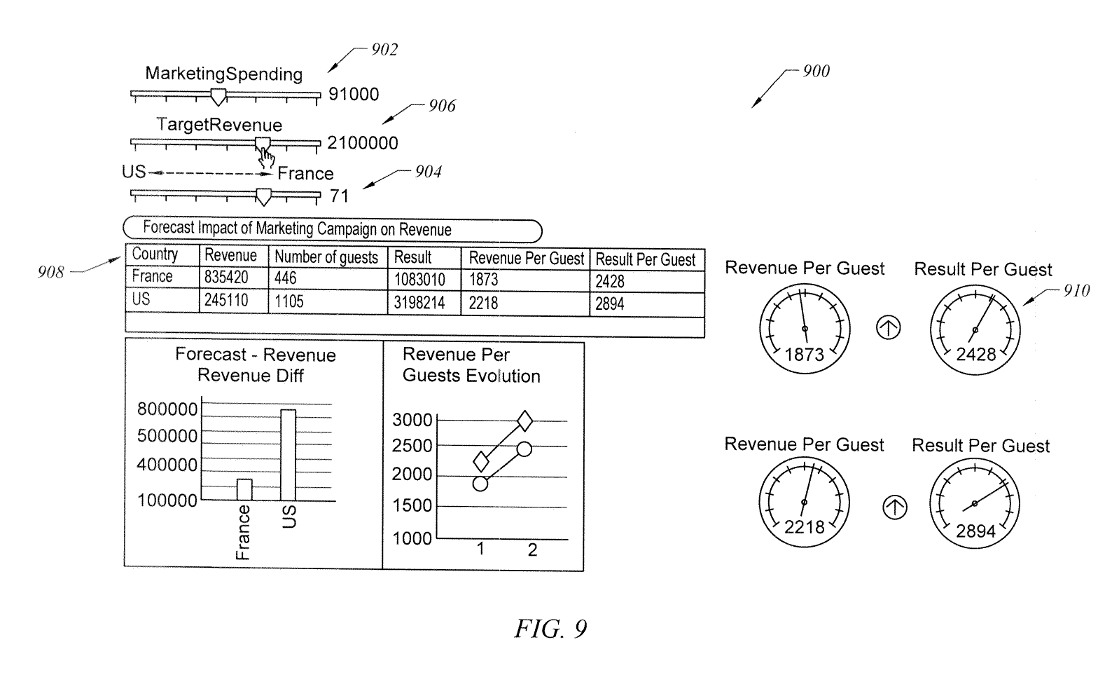

FIG. 9 illustrates an example of an input/output graphical user interface corresponding to the graphical user interface of FIG. 8. Panel 900 shows GUI components corresponding to various externally visible inputs (panels 806-810), externally visible outputs (panels 830-838), data provided by a web service (panels 814-820), and data provided to a web service (panels 842-858). Each GUI component may be automatically mapped to each data object to be displayed, as described for block 212 of FIG. 2 and block 304 of FIG. 3. Alternatively, one or more of the GUI components may be specified by a designer, as described for block 312 of FIG. 3. Panels 902, 904, and 906 show sliders corresponding to “MarketingSpending” (panel 852), “Spreading” (panel 854), and “TargetRevenue” (panel 856), respectively. Panel 908 shows a tabular display of row-based data corresponding to “RowRevenue” (panels 831 and 842), including, for each row, “Country” (panels 830 and 844), “Revenue” (panels 832 and 846), “Number_of_guests” panels 834 and 848) and “Result” (panels 836 and 858). Panel 910 shows additional result information that may correspond to “Result” (panels 838 and 858).

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

What is claimed is:

1. A computer readable storage medium, comprising executable instructions to:
compare a definition of a web service used by an application to a current definition of the web service, wherein the definition of the web service includes a description of a plurality of data parameters, and wherein the application includes a graphical user interface including at least one part that displays a data object representing an input to or an output from the web service; and
create a first updated application based on the application and the current definition of the web service, including executable instructions to modify the at least one part of the graphical user interface to correspond to the current web service definition.

2. The computer readable storage medium of claim 1, wherein the executable instructions to compare include executable instructions to detect at least one of modification of web service parameters or operations, addition of new web service parameters or operations, removal of web service parameters or operations, and changes of parameter type.

3. The computer readable storage medium of claim 1, wherein the executable instructions to compare occur after each download of the application to a client.

4. The computer readable storage medium of claim 1, wherein the executable instructions to compare occur for each call of the graphical user interface of the application, wherein the application is exposed as a web application by a server.

5. The computer readable storage medium of claim 1, wherein the executable instructions to modify include executable instructions to map the data object to a graphical user interface component.

6. The computer readable storage medium of claim 5, wherein the executable instructions to map include at least one of executable instructions to map a free form numeric data object or a string data object to a text box, to map a data object representing an enumerated list to a dropdown list, and to map a data object representing a date to a date-specific graphical user interface component.

7. The computer readable storage medium of claim 5, wherein the executable instructions to map include executable instructions to map a database query result to a chart.

8. The computer readable storage medium of claim 5, wherein the executable instructions to map are based on a selected graphical user interface layout template.

9. The computer readable storage medium of claim 1, wherein the executable instructions to create include executable instructions to generate source code for the first updated application, wherein the first updated application is executable on a selected deployment platform.

10. The computer readable storage medium of claim 9, wherein the executable instructions to generate are based on a selected application format.

11. The computer readable storage medium of claim 1, further comprising executable instructions to:
provide a notification of the creation of the first updated application; and
process a confirmation accepting the first updated application.

12. The computer readable storage medium of claim 1, further comprising executable instructions to provide a notification of a compilation failure.

13. The computer readable storage medium of claim 1, wherein the executable instructions to create include executable instructions to determine whether to request modifications to a workflow description linking a plurality of parts of the graphical user interface.

14. The computer readable storage medium of claim 13, further comprising executable instructions to request that the workflow description be modified.

15. The computer readable storage medium of claim 1, further comprising executable instructions to accept a workflow description linking a plurality of parts of the graphical user interface, wherein the workflow description corresponds to the current web service definition.

16. The computer readable storage medium of claim 15, wherein the workflow description includes at least one mapping of an output of a first part of the graphical user interface to one or more inputs of a second part of the graphical user interface, and further includes a sequencing of the plurality of parts of the graphical user interface.

17. The computer readable storage medium of claim 15, further comprising executable instructions to:
bind the plurality of parts into a combination of parts based on the workflow description; and
generate source code for a second updated application based on the combination of parts;
wherein the second updated application is executable on a selected deployment platform.

18. The computer readable storage medium of claim 15, further comprising executable instructions to incorporate user modifications to the graphical user interface.

19. The computer readable storage medium of claim 15, further comprising executable instructions to publish the second updated application to a repository.

20. A system comprising:
a client containing an application including a definition of a web service and a graphical user interface including at least one part that displays a data object representing an input to or an output from the web service wherein the definition of the web service includes a description of a plurality of data objects; and
a server that compares the definition of the web service to a current definition of the web service contained on the server, and that creates a first updated application based on the application and the current definition of the web service, including modifying the at least one part of the graphical user interface to correspond to the current web service definition.

21. The system of claim 20, wherein the current web service definition is contained in a master version of the source code of the application stored on the server.

22. The system of claim 20, wherein the server accepts a workflow description linking a plurality of parts of the graphical user interface, wherein the workflow description corresponds to the current web service definition.

23. The system of claim 22, wherein the server binds the plurality of parts into a combination of parts based on the workflow description and generates source code for a second updated application based on the combination of parts, wherein the second updated application is executable on a selected deployment platform.
